(19) United States
(12) Patent Application Publication
(10) Pub. No.: US 2013/0090018 A1
(43) Pub. Date: Apr. 11, 2013

(54) CABLE CONNECTOR

(71) Applicant: CHIH-HSIEN CHIANG, New Taipei (TW)

(72) Inventor: CHIH-HSIEN CHIANG, New Taipei (TW)

(73) Assignee: Cheng Uei Precision Industry Co., LTD., New Taipei City (TW)

(21) Appl. No.: 13/253,969

(22) Filed: Oct. 6, 2011

(51) Int. Cl. H01R 24/00

(52) U.S. Cl. 439/660

(57) ABSTRACT

Disclosed is a cable connector. The cable connector includes a female base coupled to a circuit board; a male base which is coupled to the female base has channels for inserting cables; and conductive terminals respectively coupled to the circuit board and the cables. The female base includes a bottom plate, two side walls, and a rear wall. A first engaging part and a second engaging part are respectively disposed at a front and a rear of the side walls. A first coordinating protrusion and a second coordinating protrusion are disposed at the male base respectively corresponding to the first engaging part and the second engaging part. The first engaging parts and the second engaging parts are respectively engaged with the first coordinating protrusions and the second coordinating protrusions. The cable connector of the present invention has a stable structure and a steady electrical connection.

### FIELD OF THE INVENTION

The present invention relates to a connector, and especially to a cable connector.

### BACKGROUND OF THE INVENTION

Cable connectors are widely used in network communication equipments. A cable connector is disposed on a circuit board for providing a space for inserting a cable, and the cable connector is utilized to achieve an electrical communication for the circuit board via conductive terminals thereof, so data transmission can be realized.

A conventional cable connector generally includes a female base which is disposed on the circuit board and a male base which is coupled to the cable. The connection method that the female base and the male base coupled to each other is made by embedding. For example, a positioning protrusion is disposed at a side of the male base, and a positioning groove is disposed at the female base, in which the positioning protrusion is mated to the positioning groove. However, such structures are often not stable. The positioning protrusion is easily to be separated from the positioning groove when the cable is unexpectedly pulled up, causing the male base to depart from the female base, and leading to an unsteady electrical connection therebetween to affect the signal transmission.

### SUMMARY OF THE INVENTION

An objective of the present invention is to provide a cable connector with a structural stability and a steady electrical connection in accordance with the drawback of the above-mentioned prior art.

To achieve the foregoing objectives, a cable connector provided by the present invention includes a female base coupled to a circuit board; a male base, which is coupled to the female base, having a channel for inserting cables; and a plurality of conductive terminals respectively coupled to the circuit board and the cables. The female base includes a bottom plate, two side walls, and a rear wall. A first engaging part and a second engaging part are respectively disposed at a front and a rear of the side walls. A first coordinating protrusion and a second coordinating protrusion are disposed at the male base respectively corresponding to the first engaging part and the second engaging part. The first engaging part and the second engaging part are respectively engaged with the first coordinating protrusion and the second coordinating protrusion at a front side and a rear side of the male base and the female base.

As mentioned above, the first and second engaging parts are respectively engaged with the first and second coordinating protrusion at the front side and rear sides of the male base and the female base, hence the structure of the cable connector is more stable. Even if the cable is pulled up, the male base is not easy to depart from the female base, causing a more reliable connection therebetween. Therefore, the electrical connection between the cable connector and an external circuit board are more stable, thereby ensuring a reliable signal transmission.

### BRIEF DESCRIPTION OF THE DRAWINGS

FIG. 1 is a perspective view illustrating a cable connector according to one preferred embodiment of the present invention;

FIG. 2 is an exploded view illustrating the cable connector of the present invention; and

FIG. 3 is a more detailed exploded view illustrating the cable connector of the present invention.

### DETAILED DESCRIPTION OF THE PREFERRED EMBODIMENTS

Reference will now be made in detail to the present preferred embodiment of the invention, example of which is illustrated in the accompanying drawings.

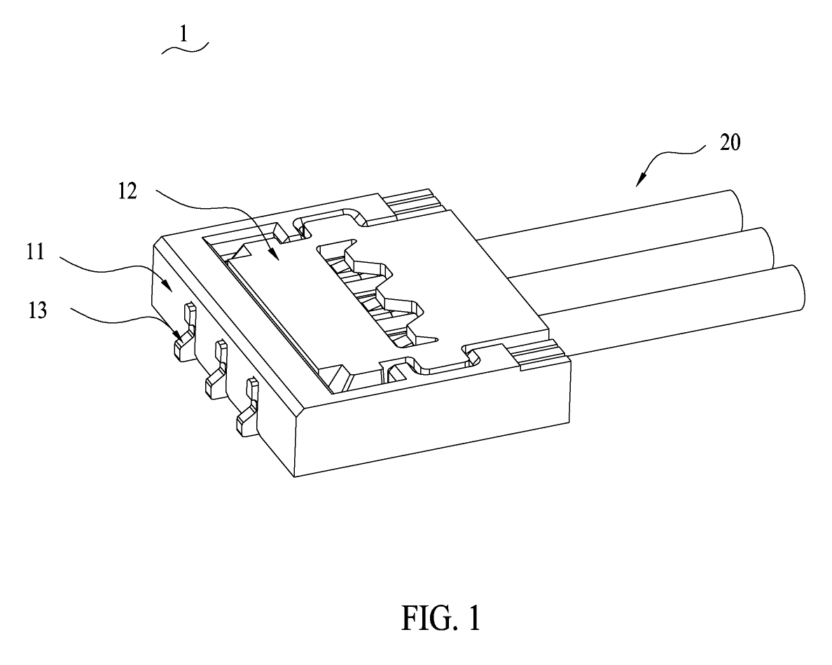

Referring to FIG. 1 to FIG. 3, a cable connector 1 of one embodiment of the present invention includes: a female base 11 being coupled to an external circuit board (not shown); a male base 12, which is coupled to the female base 11, having channels 124 for inserting cables 20, respectively; and a plurality of conductive terminals 13 being respectively coupled to the circuit board and the cables 20. The following detailed description refers to the structural stability of the connection between the female base 11 and the male base 12 of the cable connector 1 for the steady electrical connection between the cables 20 and the circuit board.

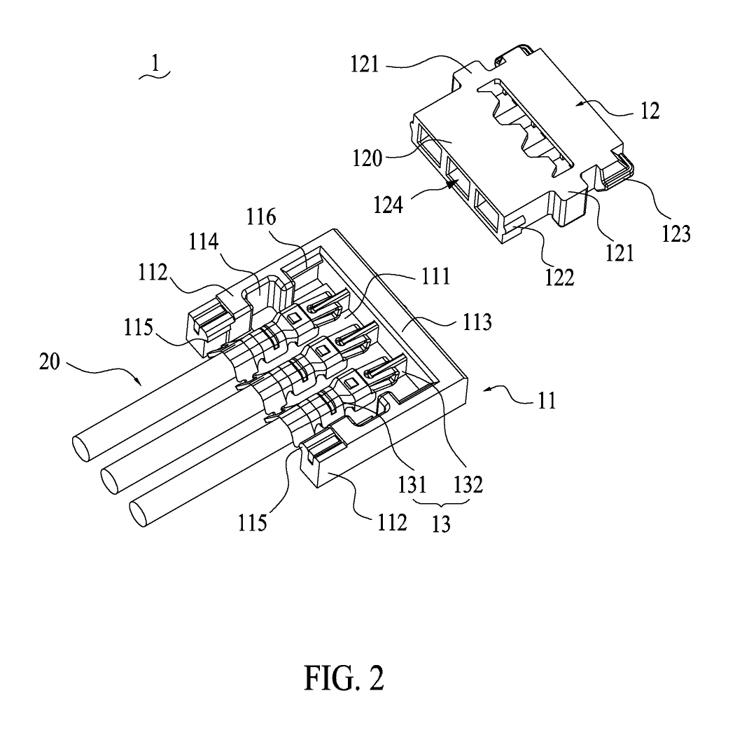

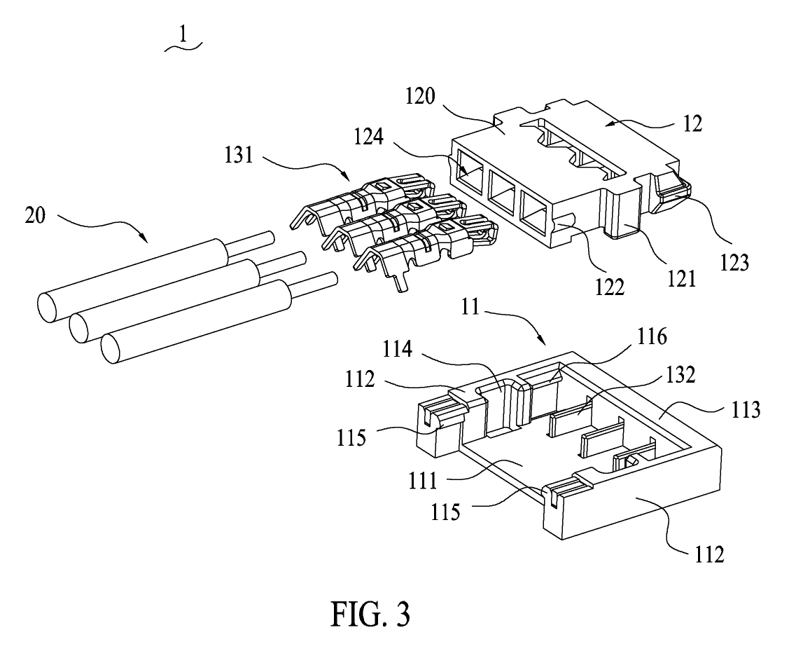

As shown in FIG. 2 and FIG. 3, the female base 11 is substantially square, and the female base 11 has a semi-enclosed receiving space (not shown). Moreover, a shape of the male base 12 corresponds to the receiving space, into which the male base 12 is inserted. Specifically, the female base 11 includes a bottom plate 111, two side walls 112 located at two opposite sides of the bottom plate 111, and a rear wall 113 located at a rear of the bottom plate 111. A positioning groove 114 is disposed at the side wall 112. Preferably, the positioning groove 114 passes through the bottom plate 111. A first engaging part 115 and a second engaging part 116 are respectively disposed at a front and a rear of the side walls 112. The first engaging part 115 and the second engaging part 116 are respectively located at two sides of the positioning groove 114, that is, the first engaging part 115 is disposed a front of the female base 11 near the cables 20, and the second engaging part 116 is disposed a rear of the female base 11 away from the cables 20. In the embodiment, the first engaging part 115 and the second engaging part 116 are protrusions.

Referring to FIG. 2 and FIG. 3, the conductive terminal 13 of the cable connector 1 of the present invention includes a first conductive terminal 131 and a second conductive terminal 132. The first conductive terminal 131 is received in a channel 124 of the male base 12. One end of the second conductive terminal 132 is disposed in the female base 11, and an opposite end extends out the female base 11 to contact the external circuit board. Specifically, after the cables 20 are electrically coupled to the first conductive terminals 131, the cables 20 are electrically coupled to the external circuit board through the second conductive terminals 132.

As mentioned above, the male base 12 includes a body 120 that defines a plurality of channels 124 for inserting the cables 20. A positioning protrusion 121 is disposed at a side of the body 120. A first coordinating protrusion 122 and a second coordinating protrusion 123 are disposed at both sides of the positioning protrusion 121 respectively corresponding to the first engaging part 115 and the second engaging part 116. Specifically, the first coordinating protrusion 122 and the second coordinating protrusion 123 are also protrusions. When the male base 12 is embedded in the female base 11, the positioning protrusion 121 of the male base 12 is inserted into the positioning groove 114 of the female base 11. The protrusion of the first engaging part 115 and the protrusion of the second engaging part 116 are respectively engaged below the protrusion of the first coordinating protrusion 122 and the protrusion of the second coordinating protrusion 123, that is, the first and second engaging parts 115, 116 are respectively positioned abutting below the first, second coordinating protrusions 122, 123, thereby realizing the engagement of the male base 12 and the female base 11.

Because the first and second engaging parts 115, 116 are respectively engaged with the first and second coordinating protrusions 122, 123 at the front side and rear sides of the male base 12 and the female base 11, the structure of the cable connector is more stable. Even if the cables 20 are unplugged, the male base 12 is not easily pulled from the female base 11, causing a more steadily connection therebetween. Therefore, the electrical connection between the cable connector 1 and an external circuit board are more stable.

Under the concept of the present invention, the mating way of the first, second engaging part 115, 116 as well as the first, second coordinating protrusions 122, 123 is not limited to be implemented by the protrusion mating to the protrusion described in the above-mentioned embodiment, and it also can be implemented by a protrusion mating to a groove, a protrusion mating to a through-hole and so on.

In summary, the first and second engaging parts 115, 116 of the cable connector 1 of the present invention are respectively engaged with the first and second coordinating protrusions 122, 123 at the front side and rear sides of the male base 12 and the female base 11, so the structure of the cable connector is more stable. Even if the cables 20 are unplugged, the male base 12 is not easily pulled from the female base 11, causing a more steadily connection therebetween. Therefore, the electrical connection between the cable connector 1 and an external circuit board are more stable, thereby ensuring a reliable signal transmission.

What is claimed is:

1. A cable connector, comprising a female base coupled to a circuit board; a male base coupled to the female base, the male base having a channel for inserting a cable; and a plurality of conductive terminals respectively coupled to the circuit board and the cables, wherein the female base comprises a bottom plate, two side walls, and a rear wall, and a first engaging part and a second engaging part are respectively disposed on a front and a rear of the side walls, and wherein a first coordinating protrusion and a second coordinating protrusion are disposed at the male base respectively corresponding to the first engaging part and the second engaging part, thereby the first engaging part and the second engaging part respectively engaging with the first coordinating protrusion and the second coordinating protrusion at the front and the rear of the side walls of the male base and the female base.

2. The cable connector of claim 1, wherein a positioning protrusion is disposed at the male base, and a positioning groove is disposed at the female base, in which the positioning protrusion is inserted into the positioning groove.

3. The cable connector of claim 2, wherein the first engaging part and the second engaging part are respectively located at two sides of the positioning groove, and the first coordinating protrusion and the second coordinating protrusion are respectively disposed at two sides of the positioning protrusion correspondingly.

4. The cable connector of claim 1, wherein the first engaging part, the second engaging part, the first coordinating protrusion, and the second coordinating protrusion are protrusions, and the first engaging part and the second engaging part are respectively engaged below the first coordinating protrusion and the second coordinating protrusion.

5. The cable connector of claim 1, wherein the first engaging part and the second engaging part are protrusions, and the first coordinating protrusion and the second coordinating protrusion are grooves which are respectively inserted into the first coordinating protrusion and the second coordinating protrusion.
